(19) United States
(12) Patent Application Publication
(10) Pub. No.: US 2024/0293924 A1
(43) Pub. Date: Sep. 5, 2024

(54) Hydraulic Tool with Outer Rotor Electric Motor

(71) Applicant: Milwaukee Electric Tool Corporation, Brookfield, WI (US)

(72) Inventors: Alex R. Kuhls, Brookfield, WI (US); Andrew R. Tess, St. Francis, WI (US); Brian Trump, Germantown, WI (US)

(21) Appl. No.: 18/590,233

(22) Filed: Feb. 28, 2024

Related U.S. Application Data
(60) Provisional application No. 63/487,852, filed on Mar. 1, 2023.

(51) Int. Cl. B25F 5/00; B25F 3/00; F15B 15/18

(52) U.S. Cl. CPC B25F 5/005; F15B 15/18; B25F 3/00

(57) ABSTRACT

A hydraulic tool including an outer rotor electric motor having a rotor and a stator, a hydraulic pump, and a gearbox coupled between the electric motor and the hydraulic pump. In one example, the stator is at least partially received within the rotor. In another example, the electric motor drives the hydraulic pump via the gearbox to pressurize hydraulic fluid within the hydraulic tool.

### CROSS-REFERENCE TO RELATED APPLICATIONS

This application claims the benefit of U.S. Provisional Application No. 63/487,852, filed Mar. 1, 2023, which is herein incorporated by reference in its entirety.

### BACKGROUND

Hydraulic power tools, such as hydraulic pumps, press tools, crimpers, cutters, lift cylinders, nut splitters, etc. are often used for performing work on a workpiece. Typically, in these tools, a hydraulic pump pressurizes hydraulic fluid via movement of a hydraulic piston. In some examples, the pump is powered via an electric motor. However, typical electric motors increase the weight and overall dimensions of the tool, which may be undesirable to an end user.

### SUMMARY

In light of the above, there is a desire to provide smaller and lighter weight hydraulic crimpers and cutters.

Some embodiments of the disclosure provide a hydraulic tool including an electric motor with an outer rotor, a stator, a hydraulic pump, and a gearbox coupled between the electric motor and the hydraulic pump. The electric motor drives the hydraulic pump via the outer rotor to pressurize hydraulic fluid within the hydraulic tool. The stator can be at least partially received within the outer rotor. In one example, the stator includes a stator mount and a stator core supported by the stator mount and defining a central bore. The rotor includes a rotor shaft arranged within the central bore of the stator core. In another example, the rotor circumferentially surrounds the stator. The motor further includes one or more magnet sets arranged circumferentially around the rotor. In one example, the magnet sets each include a pair of magnets of the same polarity.

In another example, the rotor is arranged circumferentially around and radially outward from the stator. The motor further includes one or more magnet sets arranged circumferentially around the rotor, the magnet sets each including a pair of magnets of the same polarity so that the number of magnets within the rotor is double the number of magnet sets within the rotor.

In yet another example, the tool includes a hydraulic pump, a gearbox arranged between the electric motor and the hydraulic pump, and a mounting bracket coupled to the electric motor. The mounting bracket includes a protrusion defining a thru-channel. A pin is inserted though the thru-channel and a portion of the gearbox to couple the electric motor to the gearbox.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a perspective view of an example of a hydraulic tool including an outer rotor electric motor according to aspects of the present disclosure.

FIG. 2 is a cross-sectional view of the hydraulic tool of FIG. 1.

FIG. 3 is a side view of a powertrain assembly of the hydraulic tool of FIG. 1.

FIG. 4 is a front perspective view of an outer rotor electric motor of the powertrain assembly of FIG. 3.

FIG. 5 is a rear perspective view of the outer rotor electric motor of the powertrain assembly of FIG. 4

FIG. 6 is a cross-sectional view of the outer rotor electric motor of FIG. 4.

FIG. 7 is a front exploded view of the outer rotor electric motor of FIG. 4.

FIG. 8 is a rear exploded view of the outer rotor electric motor of FIG. 4.

FIG. 9 is an exploded view of a stator assembly of the outer rotor electric motor of FIG. 4.

FIG. 10 is an exploded view of a rotor assembly of the outer rotor electric motor of FIG. 4.

FIG. 11 is an exploded view of another example of a powertrain assembly of the hydraulic tool of FIG. 1.

FIG. 12 is a perspective view of another example of a motor for use with the hydraulic tool of FIG. 1.

FIG. 13 is an exploded view of another example of a powertrain assembly of the hydraulic tool of FIG. 1.

FIG. 14 is a perspective view of the powertrain assembly of FIG. 13.

FIG. 15 is a first perspective view of a rotor of the motor of FIG. 12.

FIG. 16 is a second perspective view of the rotor of FIG. 15.

FIG. 17 is a partial cross-sectional view of the rotor of FIG. 15.

### DETAILED DESCRIPTION

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As briefly described above, hydraulic tools can be used to perform work (e.g., crimping, cutting, lifting, pressing, pumping, etc.) on a work piece, for example, a cable, rod, wire, pipe, rebar, or other components. In one example, a hydraulic tool can include a hydraulic cylinder and ram configuration, where the ram is configured to extend and retract within the cylinder. Movement of the ram generates corresponding movement in jaws, or any other implement coupled to the ram to perform a task (crimping, cutting, pressing, lifting, etc.). The hydraulic tools typically further include a hydraulic pump, which is powered by an electric motor. In one form the motor is an outer rotor electric motor. The hydraulic pump pressurizes hydraulic fluid within the hydraulic system to generate movement of the ram.

Some embodiments of the disclosure provide an outer rotor electric motor connected to the pump via a gearbox. In other examples, the outer rotor electric motor may be connected to the pump via directly (e.g., in a direct drive arrangement without a gearbox). The outer rotor electric motor is able to generate considerable torque to power the pump, so that a larger amount of force can be applied to the work piece via the crimper/cutter. Additionally, the outer rotor electric motor enables the manufacturing of smaller and lighter tools, which is beneficial to a user. Embodiments of the disclosure can provide benefits over conventional inner rotor electric motors. Example improvements include, increasing the amount of torque generated by the motor or decreasing the overall size and weight of the hydraulic tool.

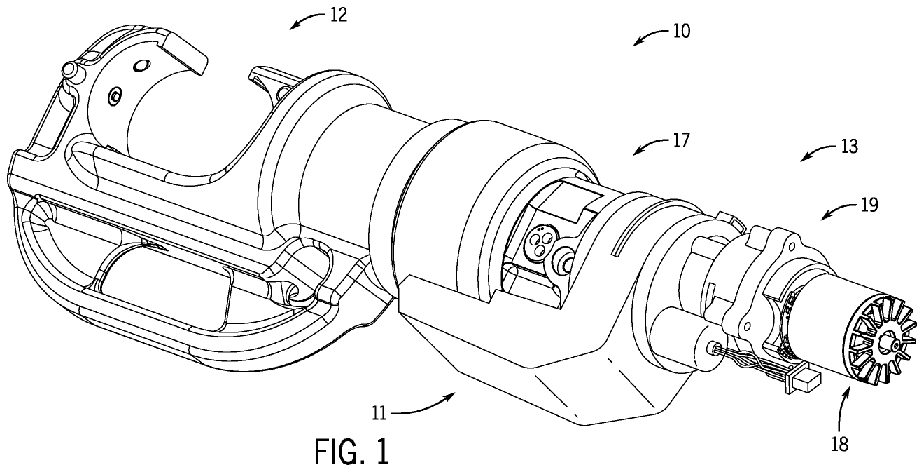

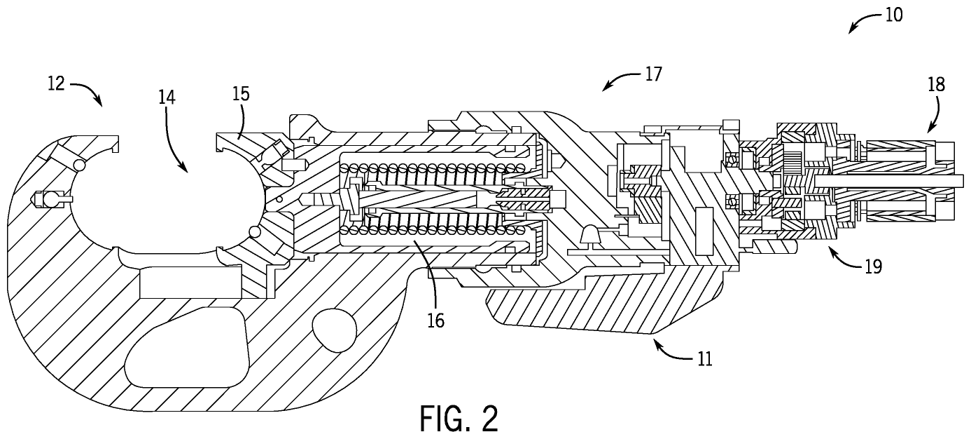

FIGS. 1 and 2 illustrate an example of a hydraulic tool 10. In one example, the hydraulic tool 10 is a hydraulic crimper/cutter tool. The tool 10 includes a head 12 connected to a body 13. In one example, as shown in FIG. 2, the head 12 defines a substantially C-shaped opening 14 configured to receive a component, for example, a wire, cable, rod, pipe, or other component to be crimped or cut by the tool 10. As shown in FIG. 2, a removable die 15 is mounted to a hydraulic ram 16 within the opening 14. The die 15 may be removed or exchanged based on the desired function of the tool 10. For example, a crimping die may be used when crimping is desired, and a cutting die may be used when cutting is desired. The die 15 may be actuated via movement of the hydraulic ram 16. In one example, the hydraulic ram 16 is actuated via a hydraulic force or pressure supplied via one or more hydraulic components 17 of the tool 10. In one example, a button 11 disposed on the body 13 of the tool 10 may be actuated by a user to advance or retract movement of the ram 16.

The hydraulic components 17 of the tool 10 may include a hydraulic pump, which pressurizes hydraulic fluid to actuate the ram 16. In one example, the hydraulic pump may be connected to an electric motor 18 via a gearbox 19. The gearbox 19 may be configured to modify an output from the electric motor 18 to enhance torque or speed produced from the electric motor 18. In another example, the hydraulic pump may be directly connected to the electric motor 18 without the gearbox 19 (e.g., via a direct drive arrangement). In one example, the electric motor is in the form of a brushless outer rotor electric motor. In another example, the motor 18 receives power from a battery pack removably coupled to the motor (e.g., in a cordless arrangement). In yet another example, the tool 10 may include a power cord for electrically connecting the motor 18 to a source of alternating current (AC) power (e.g., in a corded arrangement). Further, as should be appreciated, the outer rotor electric motor may be used with a variety of hydraulic tools of various sizes, shapes, or functions. For example, the outer rotor electric motor may be used with hydraulic pumps, hydraulic press tools, hydraulic crimpers, hydraulic cutters, hydraulic lifting cylinders, hydraulic nut splitters, or any other known hydraulic tool.

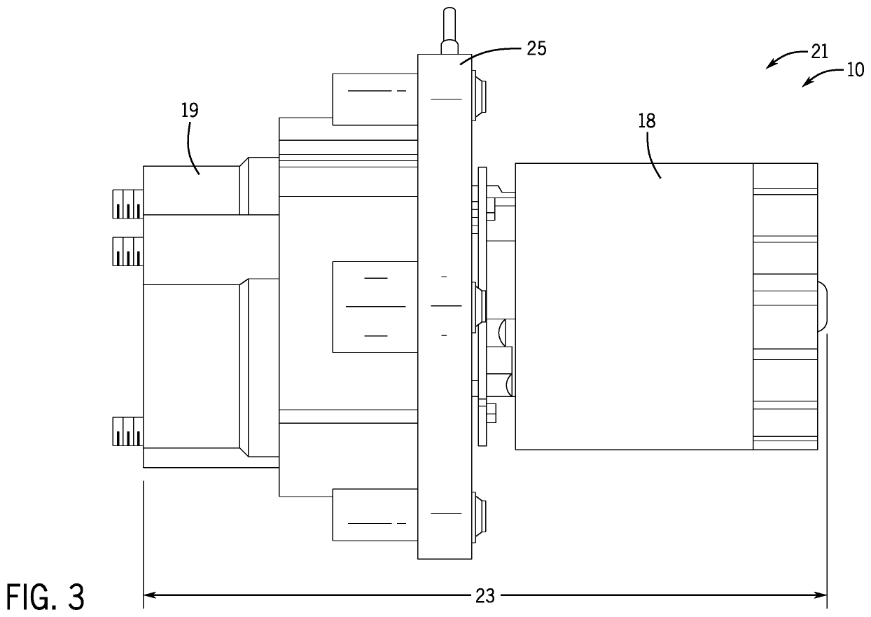

FIG. 3 shows an example of a powertrain assembly 21 of the hydraulic tool 10. The powertrain assembly 21 may include the electric motor 18 and the gearbox 19. In one example, the powertrain assembly 21 may include the electric motor 18, the gearbox 19, and an optional adapter plate 25. The adapter plate 25 may be used to connect the motor 18 to the gearbox 19. In other examples, the powertrain assembly 21 may not include the adapter plate 25 and instead the motor 18 may directly mount to the gearbox 19. As can be seen in FIG. 3, the powertrain assembly 21 may include an overall length 23. In one example, the length 23 of the powertrain assembly 21 may be less than 90 mm. In another example, the length 23 of the powertrain assembly 21 may be between 80 and 90 mm. In one example, the overall length 23 of the powertrain assembly 21 including the outer rotor electric motor 18 is less than a length of the powertrain assembly with an inner rotor electric motor.

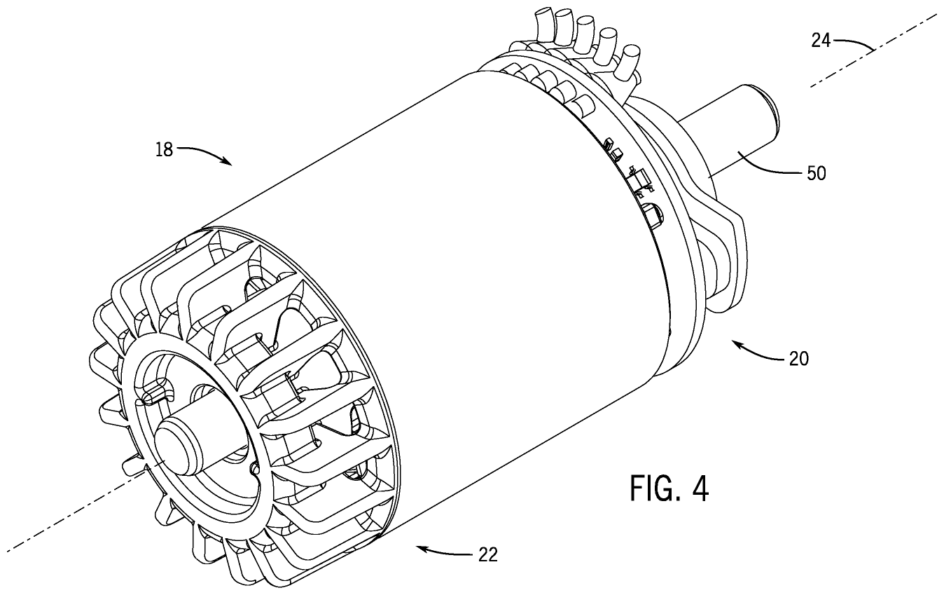

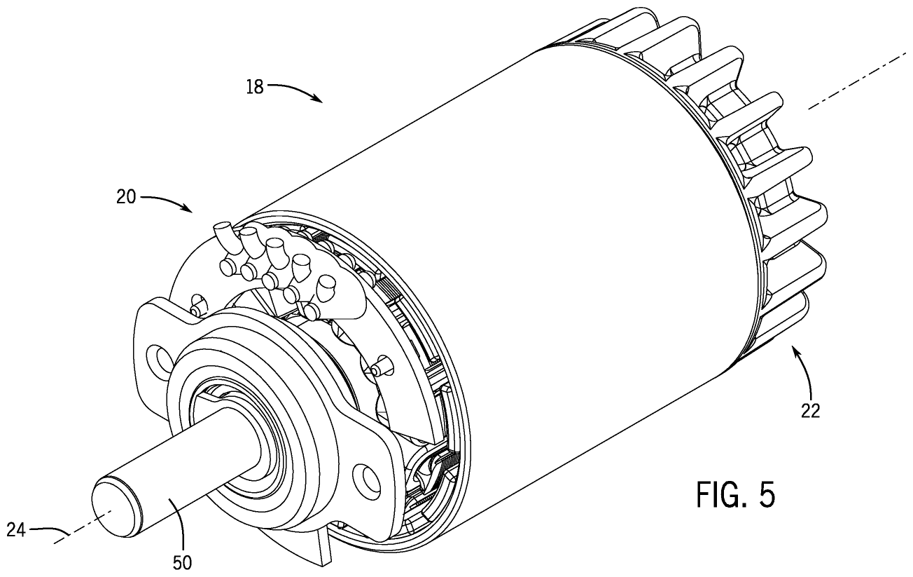

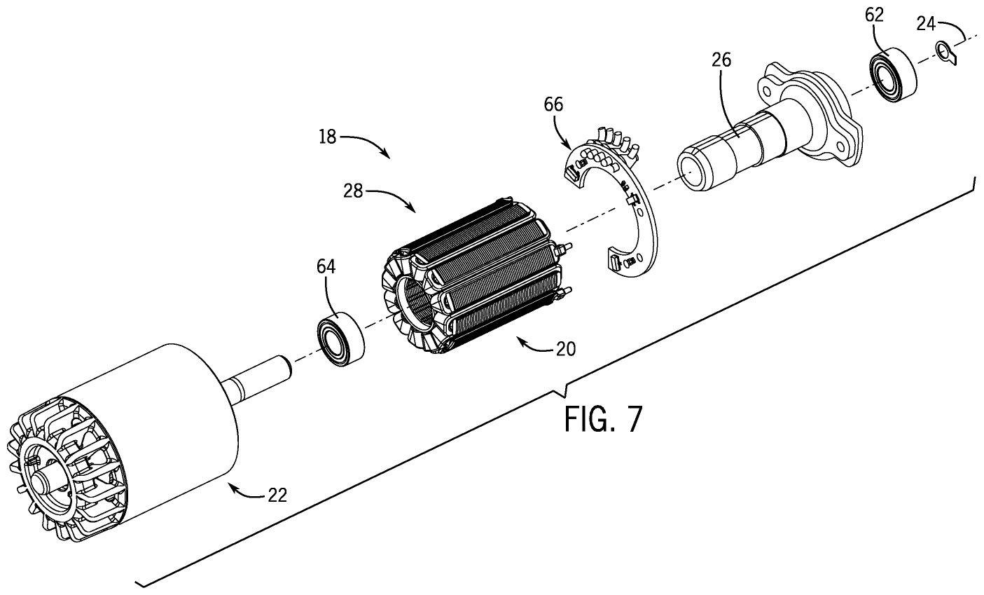

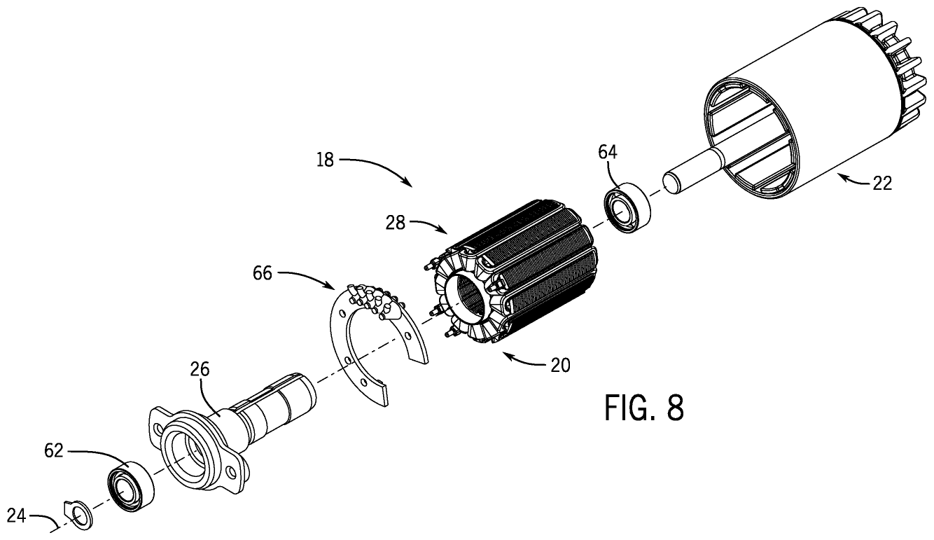

With reference to FIGS. 4-10, the motor 18 is a brushless direct current (“BLDC”) electric motor with a stator 20 and a rotor 22 that is rotatable with respect to the stator 20 about an axis 24 (see, e.g., FIG. 7). Put differently, the rotor 22 rotates about the axis 24 while the stator 20 is fixed (e.g., stationary, unable to rotate) with respect to the axis 24 and the rotor 22. The BLDC electric motor 18 is an “outer rotor” BLDC electric motor with the rotor 22 generally circumferentially surrounding the stator 20. Thus, the rotor 22 is an outer rotor 22 and the stator 20 is an inner stator 20 that is at least partially received within and generally circumferentially surrounded by the outer rotor 22.

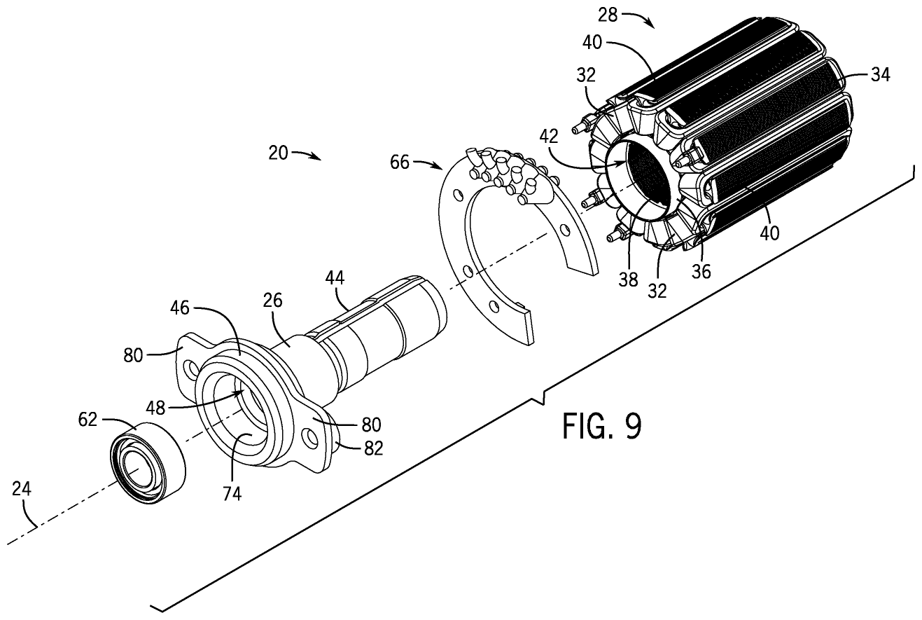

As shown in FIG. 9, the stator 20 includes a stator mount 26, a stator core assembly 28 fixedly supported by the stator mount 26, and a plurality of wires or stator windings that define a plurality of coils 32. In one example, the stator 20 includes 12 slots (e.g., coils 32). In other examples, the stator 20 may include more or less slots (e.g., coils 32). The stator core assembly 28 includes a stator core 34 formed via a stack of laminations, and an insulator 36 molded to the core 34. The stator core 34 includes a central core back 38 and a plurality of teeth 40 protruding outwardly from the core back 38. The coils 32 are formed about (e.g., surrounding) the teeth 40 and insulated from the teeth 40 by the insulator 36. The core back 38 defines a core central bore 42 that extends longitudinally through the stator core assembly 28. The stator mount 26 includes an elongated stator support portion 44 and a motor support portion 46 located at one end of the stator support portion 44. The stator support portion 44 is sufficiently tubular in shape and supports the stator core assembly 28. More specifically, the core central bore 42 of the stator core 34 receives the stator support portion 44. Thus, the stator core assembly 28 is rigidly supported about the stator support portion 44.

Put differently, the stator core assembly 28 is circumferentially disposed about the stator support portion 44. In some examples, the stator core 34 can receive the stator support portion 44 by press fit or interference fit. In other examples, the stator support portion 44 can be affixed to the stator core 34 by a molding process. The stator mount 26 further defines a hollow mount central bore 48 extending longitudinally through the stator mount 26, including through both of the stator support portion 44 and the motor support portion 46.

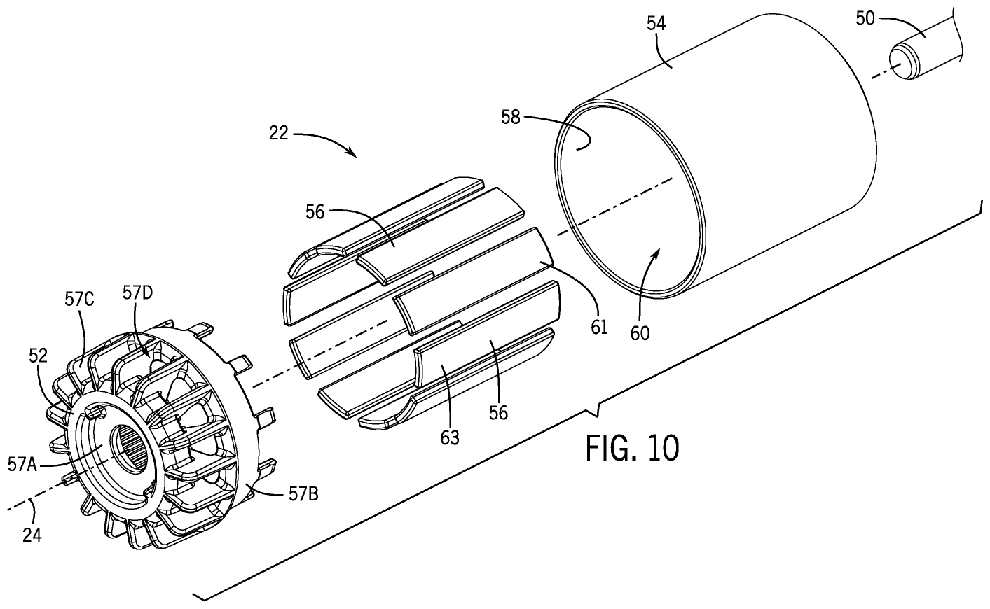

As shown in FIG. 10, the rotor 22 includes a central rotor shaft 50, a rotor frame 52, a tubular rotor body 54, and a plurality of permanent magnets 56. For example, the permanent magnets 56 may include magnets of differing polarities. As an example, the magnets may include one or more magnets of a first polarity 61 and one or more magnets of a second polarity 63. The magnets may be alternated around the rotor 22. For example, the magnets 56 may alternate between magnets of a first polarity 61 and magnets of a second polarity 63.

The rotor frame 52 may be annular in shape and include a central portion 57A configured to receive the rotor shaft 50. An outer peripheral portion 57B of the rotor frame 52 may be affixed to the rotor body 54. The rotor frame 52 affixes the rotor body 54 to the rotor shaft 50 for co-rotation. Put differently, the rotor frame 52 secures the rotor body 54 to the rotor shaft 50 to permit rotation of the rotor shaft 50 to elicit corresponding rotation of the rotor body 52.

A plurality of radially and axially extending blades 57C extend between and connect the central portion 57A to the outer peripheral portion 57B. A plurality of airflow apertures 57D are defined between each pair of adjacent blades 57C. The blades 57C operate as a fan to generate an airflow that passes through the airflow apertures to cool the electric motor 18. In some examples, the rotor frame 52 can be formed from a metal or metal alloy (e.g., zinc or steel). In other embodiments, the frame 52 can be molded from a resin material.

The rotor body 54 may be tubular in shape and have a radially inner surface 58 that defines a central cavity 60. The permanent magnets 56 may be fixedly supported on the radially inner surface 58 of the rotor body 54. In one example, the motor 18 may be a ten (10) pole motor with ten (10) permanent magnets 56. In other examples, the motor may include more or less than ten (10) permanent magnets. The number of magnets 56 may be evenly divided between first polarity 61 and second polarity 63 magnets.

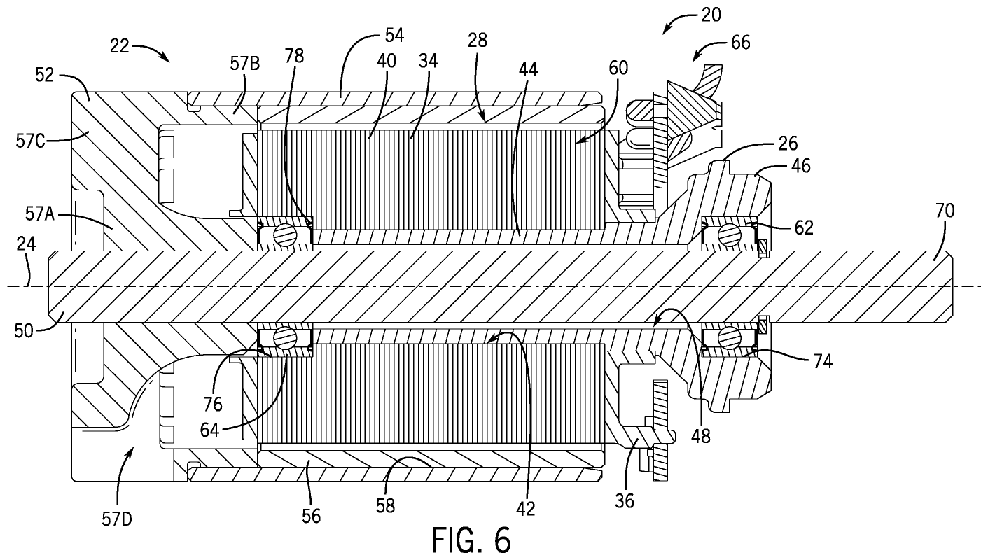

As shown in FIG. 6, the rotor body 54 is located radially outward from the stator 20 and surrounds portions of the stator 20, including the stator core assembly 28, the coils 32, and portions of the stator mount 26. Portions of the stator 20, including all or generally most of the stator core assembly 28, are received within the central cavity 60 of the rotor body 54. The rotor shaft 50 is rotatably supported relative to the stator 20 by one or more bearings including a first bearing 62 and a second bearing 64. Thus, the rotor 22 (i.e., including the rotor shaft 50, the rotor frame 52, the rotor body 54, and the magnets 56) rotate relative to the stator 20. The rotor shaft 50 extends centrally through the stator 20, both through the core central bore 42 and the mount central bore 48.

In one example, the motor 18 may include an annular printed circuit board assembly (PCBA) 66 affixed to the insulator 36 of the stator 20 (see, e.g., FIG. 9). The PCBA 66 can include at least one position sensor. For example, the PCBA may include a Hall effect sensor to detect a position of the permanent magnets 56 of the rotor 22. In additionally or alternatively, the PCBA 66 can include a plurality of switching circuits (e.g., Field-Effect Transistors (FETs)) operable to electrically commutate the motor 18. In some examples, the motor 18 may not include the PCBA 66 (e.g., in sensor-less motor drive arrangements).

The rotor shaft 50 includes an output end 70 that protrudes beyond the motor support portion 46 of the stator mount 26. The output end 70 can fixedly couple to an output member (e.g., a gear, a pump, etc.). For example, the output end 70 may couple to the hydraulic components 17 in order to pressurize hydraulic fluid used to actuate the ram 16. In other examples, the output end 70 may be coupled to the hydraulic components 17 via the gearbox 19. The output end 70 enables the transfer of rotational power or movement generated by the motor 18 to other components of the tool 10. In operation, the coils 32 are electrically energized (e.g., via the battery pack) to cause the rotor 22 to rotate relative to the stator 20. The alternating polarity within the coils coupled with the alternating polarity of the magnets 56 maintains rotation of the rotor 22 as long as current is provided to the motor (e.g., via the battery pack). The rotor shaft 50, the frame 52, and the rotor body 54 co-rotate together and rotate relative to the stationary stator 20 and PCBA 66. The outer rotor electric motor design enables a larger number of poles (i.e., magnets) and a larger number of slots (i.e., coils) within the electric motor, which enables a larger overall torque to be produced by the motor.

The first bearing 62 is received into a first bearing pocket 74 defined in the motor support portion 46 of the stator mount 26. An outer race of the first bearing 62 is fixedly held by the motor support portion 46, within the first bearing pocket 74, and an inner race of the first bearing 62 rotatably supports the rotor shaft 50. The inner race of the first bearing 62 enables free rotation of the rotor shaft 50, without translating corresponding rotation to the stator mount 26.

The second bearing 64 is received into a second bearing pocket 76 defined by the stator core 34. The second bearing pocket 76 is defined at an axial end of the stator core 34 and located adjacent the core central bore 42. In one example, both the second bearing pocket 76 and the core central bore 42 have circular cross-sectional shapes. In the illustrated embodiment, the second bearing pocket 76 has a larger diameter than the core central bore, defining a shoulder or step 78. An outer race of the second bearing 64 is fixedly held by the stator core 34 within the second bearing pocket 76. An inner race of the second bearing 64 rotatably supports the rotor shaft 50. The outer race of the second bearing 64 abuts the step 78 and the rotor frame 52, so that the step 78 and the rotor frame 52 prevent movement of the second bearing 64 in the axial direction. The inner race of the second bearing 64 enables free rotation of the rotor shaft 50, without translating corresponding rotation to the stator core 34.

Looking at FIG. 9, the motor support portion 46 includes a pair of radially protruding tabs 80 located opposite one another about the axis 24, and a pair of corresponding screw bosses 82 formed within the tabs 80. The screw bosses 82 are configured to selectively receive one or more fasteners (e.g., screws, nuts, bolts, or other fasteners) to secure the stator mount 26 to a motor support configured to support the motor 18.

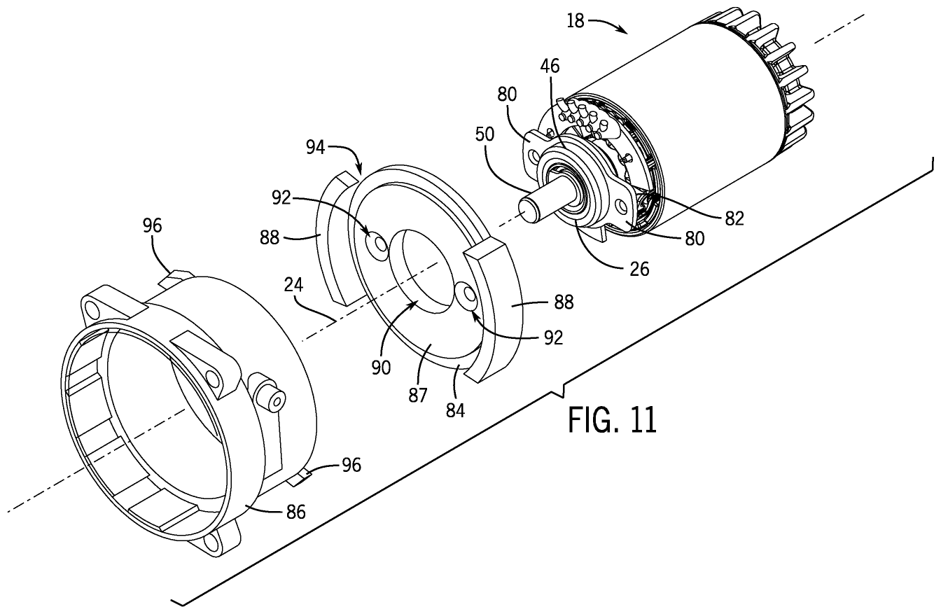

As shown in FIG. 11, the motor 18 can also include a modular adapter plate 84 that removably couples to the motor support portion 46 of the stator mount 26 (e.g., via one or more threaded fasteners). The adapter plate 84 is further configured to removably couple to a stationary component. For example, the adapter plate 84 may couple to a gearbox 86. The adapter plate 84 includes a base plate 87 and a pair of annular outer bayonet couplers 88 formed at a periphery of the base plate 87 and located generally opposite one another with respect to the axis 24. The base plate 87 defines a central aperture 90 that enables the rotor shaft 50 to pass through the base plate 87. The base plate 87 also defines a pair of fastener apertures 92 that correspond to (e.g., are aligned with) the two screw bosses 82 formed on the stator mount 26. The outer bayonet couplers 88 define slots 94 configured to receive a pair of outwardly protruding tabs 96 extending from the gearbox 86. Put differently, the slots 94 of the bayonet couplers 88 receive the tabs 96 of the gearbox 86 to secure the adapter plate 84 to the gearbox 86 to couple the stator mount 26 to the gearbox 86. Thus, the motor 18 may be secured to the gearbox 86 via the adapter plate 84, instead of directly connected to the gearbox 86.

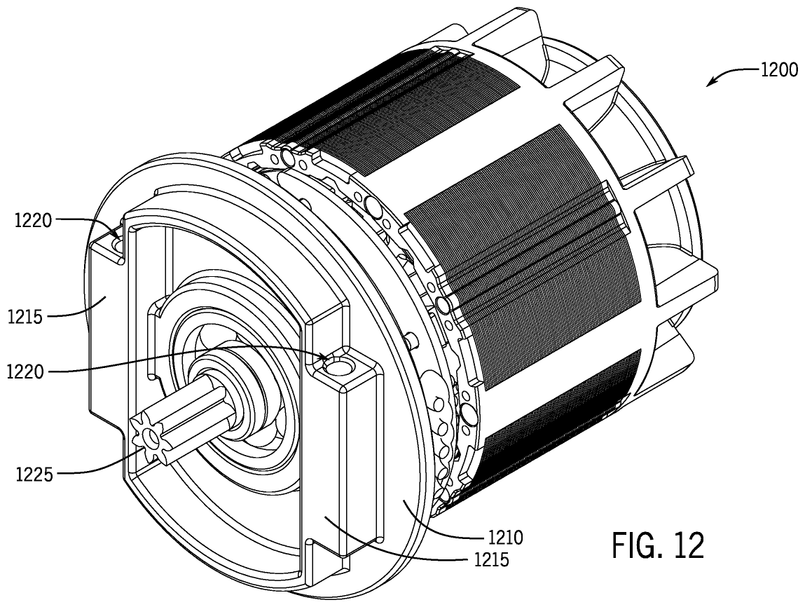

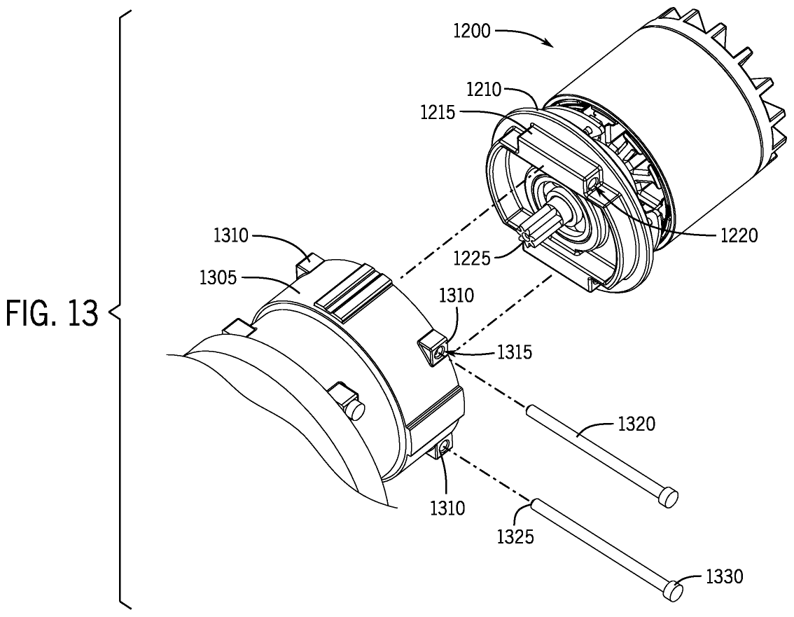

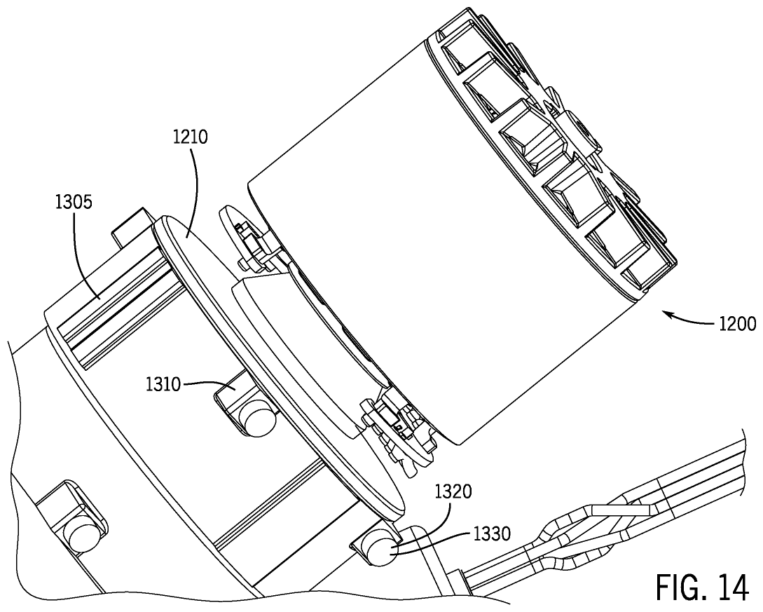

FIGS. 12-14 illustrate another example of a motor 1200 including a mounting bracket 1210 to facilitate a pinned connection between the motor 1200 (e.g., via the mounting bracket 1210) and a gearbox 1305. As should be appreciated, the use of the mounting bracket 1210 may facilitate a direct connection between the motor 1200 and the gearbox 1305 without the need for an adapter plate, thus decreasing an overall size and the overall weight of the tool.

In one example, the mounting bracket 1210 may include a pair of opposing protrusions 1215 integrated into the mounting bracket 1210. The protrusions 1215 may each include a thru-channel 1220 extending through the protrusions 1215. In one example, the mounting bracket 1210 may be partially inserted into the gearbox 1305 so that the thru-channels 1220 of the protrusions 1215 are aligned with openings 1315 of one or more mounting tabs 1310 integrated into the gearbox 1305. To secure the motor 1200 to the gearbox 1305, one or more pins 1320 may be arranged through both the openings 1315 and the thru-channels 1220. In one example, the pins 1320 may include a substantially tubular body with a first end 1325 having a size (e.g., diameter) that is dimensionally smaller than a second end 1330 of the pins 1320.

In an example use case, the motor 1200 including the mounting bracket 1210 may be partially inserted into the gearbox 1305 and oriented so the thru-channels 1220 align with the openings 1315 of the gearbox 1305. Following this, the first end 1325 of the pins 1320 may be inserted into the openings 1315 and a force applied to the pins 1320 so that the body of the pins 1320 passes through the thru-channels 1220 until the second end 1330 of the pins 1320 abuts the mounting tabs 1310 of the gearbox 1305. Put differently, the size (e.g., diameter) of the second end 1330 of the pins 1320 may be sized to prevent insertion of the second end 1330 of the pins 1320 from passing into or through the openings 1315 or the thru-channels 1220.

In another example, to further secure the motor 1200 to the gearbox 1305, the motor 1200 may include a motor shaft 1225 that includes a patterned or hobbed surface, which may reduce an overall length of the motor 1200 and gearbox 1305. In one example, the gearbox 1305 may include an input gear that may be hobbed or pressed onto the corresponding motor shaft 1225 to connect the gearbox 1305 and the motor 1200. As should be appreciated, hobbing the motor shaft 1225 to the gearbox 1305 may reduce the need for additional connection components, which may reduce an overall length of the tool 100.

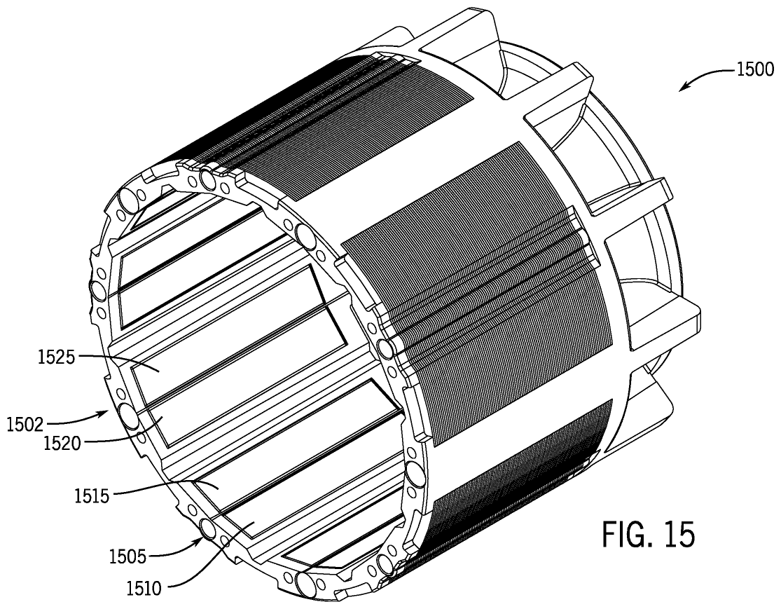

FIGS. 15-17 illustrate another example of a rotor 1500 that can be used with the tool 10 of FIG. 1 (e.g., as an alternative configuration of the rotor 22). As will be recognized, the rotor 1500 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the rotor 1500.

In one example, the rotor 1500 that includes one or more sets of magnets arranged around the circumference of the rotor 1500. For example, the rotor 1500 may include one or more first magnet sets 1502 including one or more magnets (e.g., a pair of magnets) of a first polarity and one or more second magnet sets 1505 including one or more magnets (e.g., a pair of magnets) of a second, different polarity. In one example, the each of the magnets within a magnet set (e.g., first magnet set 1502 or second magnet set 1505) may be magnets of the same polarity. For example, the first magnet set 1502 may include a first magnet 1520 of a first polarity and a second magnet 1525 of the same polarity (e.g., first polarity). Correspondingly, the second magnet set 1505 may include a first magnet 1510 of a second polarity and a second magnet 1515 of the same (e.g., second polarity), which is different from the first polarity of the first magnet set 1502. Further, the magnets may be in the form of flat magnets, arc magnets, or a combination of flat and arc magnets.

In one particular example, the motor 1200 may include the rotor 1500 so that the motor 1200 may be a ten (10) pole motor with twenty (20) permanent magnets. Put differently, the motor 1200 may include ten (10) magnet sets (e.g., five (5) first magnet sets 1502 and five (5) second magnet sets 1505) each including a pair of permanent magnets (e.g., magnets 1510/1515 or magnets 1520/1525). In one example, the number of magnet sets and magnets may be evenly divided between the first polarity and the second polarity.

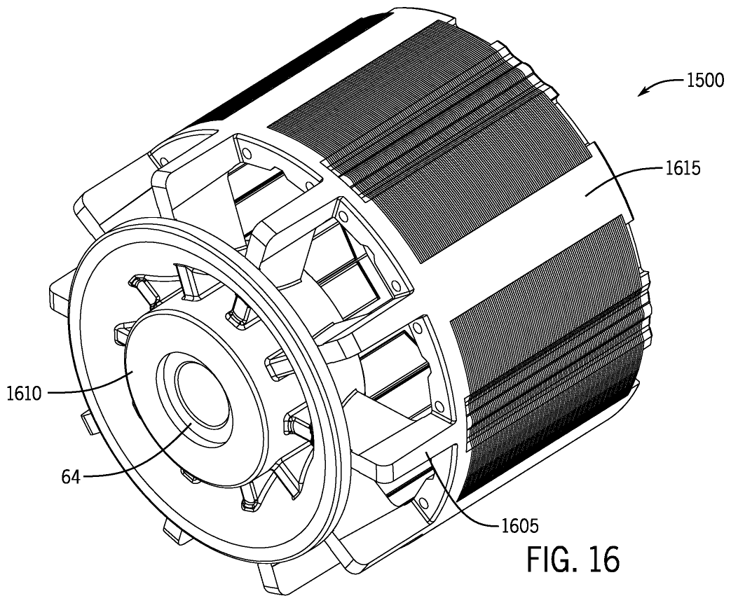

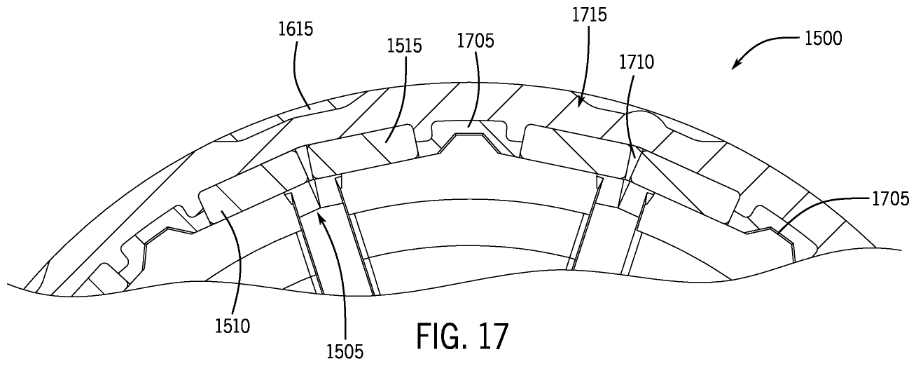

Looking at FIGS. 16 and 17, the rotor 1500 may include a frame 1615, which may be in the form of a molded frame (e.g., overmolded from a polymeric material). In one example, the frame 1615 may be molded to include an integral fan 1605 to cool the motor 1200. In another example, the frame 1615 may include an integral bearing retention pocket 1610 to retain the second bearing 64. Put differently, the frame 1615 may be molded in a single piece, unitary frame including the fan 1605 and the bearing retention pocket 1610.

In one example, the frame 1615 may further include one or more magnet retention ribs 1705. The retention ribs 1705 may work together with a divider 1710 further molded into the frame 1615 to retain the magnets (e.g., magnets 1510, 1515, 1520, 1525) of the magnet sets (e.g., magnet sets 1502, 1505). For example, the retention ribs 1705 and the divider 1710 to define slots 1715 circumferentially surrounding the rotor 1500. In one example, the slots 1715 may receive and retain a magnet (e.g., a magnet 1510, 1515, 1520, 1525) between a retention rib 1705 and a divider 1710. Further, the space between sets of retention ribs 1705 may define the magnet sets (e.g., the magnet sets 1502, 1505). In one example, the slots 1715 may be configured to receive and retain both arc and flat magnets via the retention ribs 1705 and the divider 1710.

In some implementations, devices or systems disclosed herein can be utilized, manufactured, or installed using methods embodying aspects of the disclosure. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosure, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein in the context of cable connectors, unless otherwise limited or defined, “axial” and derivatives refer to an axial direction of an elongate cable that is received into (e.g., fully through) the relevant connector. Thus, for example, with a cylindrical cable received through a housing and insert of a cable connector, an axial direction is a direction along a centerline of the cable within the housing and insert. Correspondingly, unless otherwise limited or defined, “radial” indicates a direction perpendicular to axial, and the terms “inward” and “outward” indicate movement transverse to axial, toward and away from a reference centerline, respectively.

Additionally, unless otherwise specified or limited, the terms “about” and “approximately,” as used herein with respect to a reference value, refer to variations from the reference value of ±25% or less, inclusive of the endpoints of the range. Similarly, the term “substantially equal” (and the like) as used herein with respect to a reference value refers to variations from the reference value of less than ±15%, inclusive. Where specified, “substantially” can indicate in particular a variation in one numerical direction relative to a reference value. For example, “substantially less” than a reference value (and the like) indicates a value that is reduced from the reference value by 15% or more, and “substantially more” than a reference value (and the like) indicates a value that is increased from the reference value by 15% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the disclosure. Given the benefit of this disclosure, various modifications to these embodiments will be readily apparent to those skilled in the art, and the principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. A hydraulic tool, comprising:
an electric motor including an outer rotor and a stator, the stator at least partially received within the outer rotor;
a hydraulic pump; and
a gearbox coupled between the electric motor and the hydraulic pump;
the electric motor driving the hydraulic pump via the gearbox to pressurize hydraulic fluid within the hydraulic tool.

2. The hydraulic tool of claim 1, further comprising:
a mounting bracket coupled to the electric motor, the mounting bracket including a protrusion defining a thru-channel; and
a pin inserted though the thru-channel and a portion of the gearbox to couple the electric motor to the gearbox.

3. The hydraulic tool of claim 2, wherein the gearbox includes a mounting tab defining an opening, and wherein when the thru-channel of the mounting bracket and the opening of the mounting tab are aligned, the pin is inserted through the opening and the thru-channel to couple the electric motor to the gearbox.

4. The hydraulic tool of claim 3, wherein the pin includes a first end having a first diameter and a second end having a second diameter larger than the first diameter.

5. The hydraulic tool of claim 4, wherein the second diameter of the second end of the pin is larger than a first diameter of the opening and a third diameter of the thru-channel so that the second end of the pin cannot pass through the opening or the thru-channel.

6. The hydraulic tool of claim 1, wherein the outer rotor includes a plurality of magnet sets arranged circumferentially around the outer rotor.

7. The hydraulic tool of claim 6, wherein at least one of the plurality of the magnet sets includes a pair of magnets of a same polarity.

8. The hydraulic tool of claim 7, wherein a first number of magnets within the outer rotor is double a second number of magnet sets within the outer rotor.

9. The hydraulic tool of claim 6, wherein the outer rotor includes a frame having one or more retention ribs and one or more dividers, and wherein the one or more retention ribs and the one or more dividers together retain magnets within the outer rotor.

10. The hydraulic tool of claim 9, wherein the frame includes an integral fan.

11. The hydraulic tool of claim 9, wherein the frame is a one-piece molded body.

12. The hydraulic tool of claim 1, wherein pressurized hydraulic fluid actuates a hydraulic ram to actuate a die mounted to an end of the hydraulic ram and positioned within an opening of the hydraulic tool.

13. The hydraulic tool of claim 1, wherein the electric motor is a brushless direct current electric motor.

14. The hydraulic tool of claim 1, further comprising:
an annular printed circuit board fixed to the stator, the annular printed circuit board including a position sensor to sense a position of the outer rotor.

15. The hydraulic tool of claim 1, further comprising:
an adapter plate to removably couple the electric motor to the gearbox, the adapter plate arranged between the stator and the gearbox.

16. A hydraulic tool, comprising:
a hydraulic pump;
an electric motor, including:
a stator including a stator mount and a stator core supported by the stator mount, the stator core defining a central bore;
an outer rotor including a rotor shaft arranged within the central bore of the stator core, and the outer rotor circumferentially surrounding the stator; and
one or more magnet sets arranged circumferentially around the outer rotor,
the one or more magnet sets including a pair of magnets of the same polarity; and
the electric motor driving the hydraulic pump via the rotor shaft to pressurize hydraulic fluid within the hydraulic tool.

17. The hydraulic tool of claim 16, wherein a first number of magnets within the outer rotor is double a second number of magnet sets within the outer rotor.

18. The hydraulic tool of claim 16, wherein the outer rotor includes a frame having one or more retention ribs and one or more dividers, and wherein the one or more retention ribs and the one or more dividers together retain the magnets within the outer rotor.

19. The hydraulic tool of claim 18, wherein the outer rotor, including the rotor shaft and the frame, rotates relative to the stator and a stationary printed circuit board fixed to the stator.

20. The hydraulic tool of claim 16, wherein the hydraulic tool includes a gearbox mounted to the outer rotor shaft between the electric motor and the hydraulic pump.

21. The hydraulic tool of claim 20, further comprising:
a mounting bracket coupled to the electric motor, the mounting bracket including a protrusion defining a thru-channel; and
a pin inserted though the thru-channel and a portion of the gearbox to couple the electric motor to the gearbox.

22. The hydraulic tool of claim 21, wherein the gearbox includes a mounting tab defining an opening, and wherein when the thru-channel of the mounting bracket and the opening of the mounting tab are aligned the pin is inserted through the opening and the thru-channel to couple the electric motor to the gearbox.

23. The hydraulic tool of claim 22, wherein a second diameter of a second end of the pin is larger than a first diameter of the opening and a third diameter of the thru-channel so that the second end of the pin cannot pass through the opening or the thru-channel.

24. A hydraulic tool, comprising:
an electric motor, including:
a stator including a stator mount and a stator core supported by the stator mount, the stator core defining a central bore;
an outer rotor including a rotor shaft arranged within the central bore of the stator core, and the outer rotor arranged circumferentially around and radially outward from the stator; and
one or more magnet sets arranged circumferentially around the outer rotor, the one or more magnet sets including a pair of magnets of the same polarity with a first number of magnets within the outer rotor being double a second number of magnet sets within the outer rotor;
a hydraulic pump;
a gearbox between the electric motor and the hydraulic pump;
a mounting bracket coupled to the electric motor, the mounting bracket including a protrusion defining a thru-channel; and
a pin inserted though the thru-channel and a portion of the gearbox to couple the electric motor to the gearbox;
the electric motor driving the hydraulic pump via the gearbox to pressurize hydraulic fluid within the hydraulic tool.

25. The hydraulic tool of claim 24, further comprising:
an annular printed circuit board fixed to the stator, the annular printed circuit board including a position sensor to sense a position of the outer rotor.

26. The hydraulic tool of claim 24, wherein the electric motor and the gearbox together define a powertrain assembly, and wherein the powertrain assembly defines a length of less than 90 mm.
